(19) United States
(12) Patent Application Publication
(10) Pub. No.: US 2009/0190364 A1
(43) Pub. Date: Jul. 30, 2009

(54) Table Lamp

(76) Inventor: Chia-Ho Su, Lin-Ko County (TW)

Correspondence Address: LIN & ASSOCIATES INTELLECTUAL PROPERTY, INC., P.O. BOX 2339, SARATOGA, CA, 95070-0339, US

(21) Appl. No.: 12/170,429

(22) Filed: Jul. 9, 2008

(30) Foreign Application Priority Data
Jan. 24, 2008 (TW) 097201574

(51) Int. Cl. F21S 8/08

(52) U.S. Cl. 362/414

(57) ABSTRACT

A table lamp includes a base with a recess defined in a top thereof and a connection member extends from a surface of the recess. A rod is pivotably connected to the connection member. A shade made by semi-transparent or transparent material is pivotably connected to the rod. A first decoration member is received in the recess and a transparent cover is mounted to the recess. The shade includes an opening and an end member is removably connected with the opening. A second decoration member is received in the shade. The first and second decoration members can be replaced to meet different requirements for interior design needs.

### BACKGROUND OF THE INVENTION

1. Field of the Invention

The present invention relates generally to a table lamp with decoration members installed to a base and a shade thereof.

2. The Prior Arts

A table lamp provides illumination for the user to read or simply provides illumination to an area around the table. Some table lamps include elegant and beautiful shapes which further provide a specific function for purpose of interior design.

The modern table lamps include functions that are much more than providing illumination, such as innovation on shapes and colors. Some even are cooperated with alarm clock, flashing light bulbs, stationery box.

Nevertheless, the conventional table lamps mentioned above have inherent shortcomings besides their decoration functions, beautiful shapes, alarm clocks and stationery boxes, which are the fixed decoration style. In other words, the decoration members on the conventional table lamps cannot be changed so that only few people like the fixed style of decoration and other people not. Furthermore, the colors of the conventional table lamps are fixed and cannot be replaced with different options. The fixed colors cannot fit with the color of interior of rooms when replacing new wall papers or painting with different colors. The users have to buy new table lamps to fit the new colors of the rooms.

### SUMMARY OF THE INVENTION

A primary objective of the present invention is to provide a table lamp in which a base and a shade include decoration members, which can be replaced so as to meet different requirements for interior design needs.

The solution of the present invention is to provide a table lamp which comprises a base having a recess defined in a top thereof and a connection member extends from a surface of the recess. A first decoration member is received in the recess. A transparent cover is mounted to the recess and includes a notch with which the connection member is engaged. A rod has a first end pivotably connected to the connection member. A shade is a semi-transparent or transparent member and connected to a second end of the rod. The shade includes an opening and an end member is removably connected with the opening. A second decoration member is received in the shade.

Another objective of the present invention is to provide a table lamp, in which the cover includes two protrusions, and the recess of the base includes two engaging holes. The cover is mounted to the recess by engaging the protrusions with the engaging holes and can be easily removed from the recess so as to replace the decoration member.

Another object of the present invention is to provide a table lamp in which the shade includes a connection post and a connection tab, and the end member includes a mounting hole and an insertion removably engaging with the connection post and the connection tab, such that the decoration member received in the shade can be replaced by dismounting the end member from the shade so as to achieve different decoration purposes.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a table lamp in accordance with the present invention;

FIG. 2 is an exploded view to show the table lamp in accordance with the present invention; and

FIG. 3 is an exploded view to show a shade and an end member of the table lamp in accordance with the present invention.

### DETAILED DESCRIPTION OF THE PREFERRED EMBODIMENT

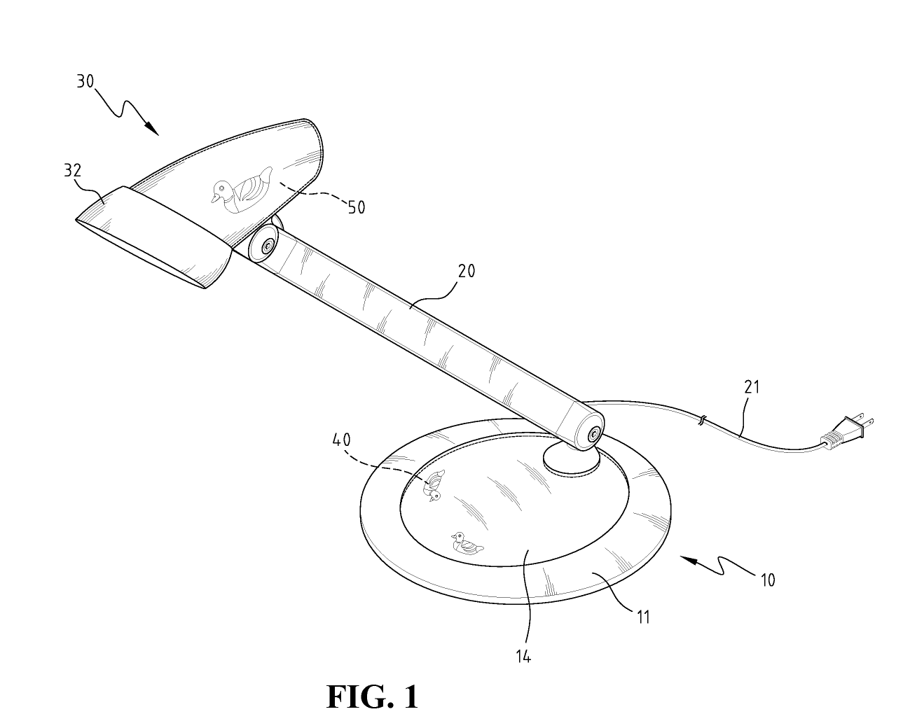

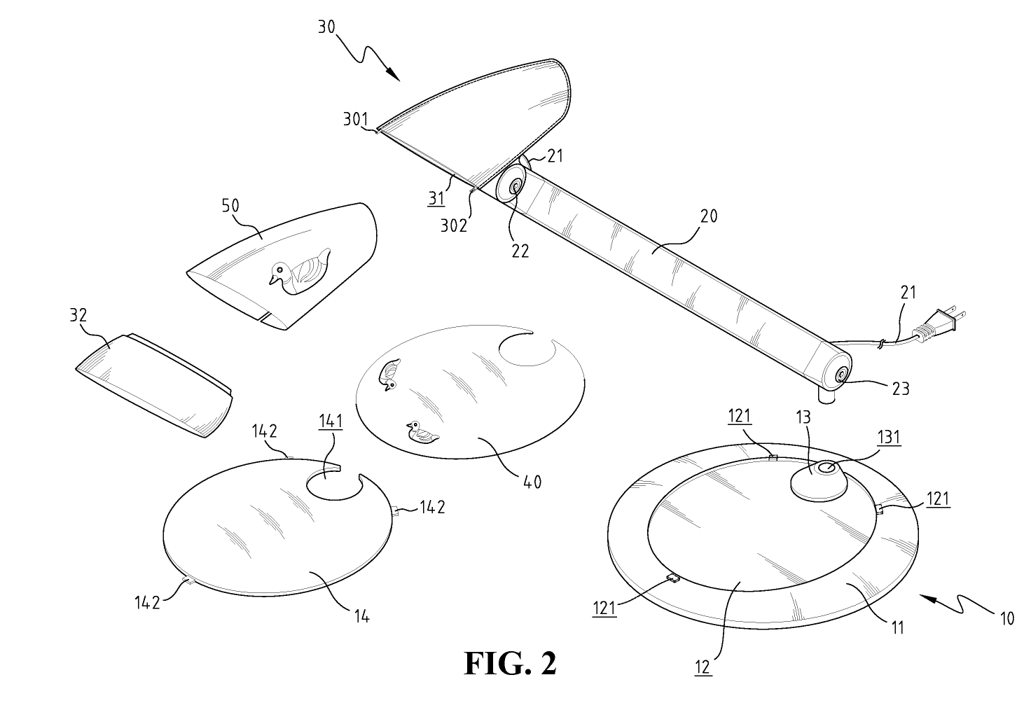

With reference to the drawings and in particular to FIGS. 1 and 2, a table lamp in accordance with the present invention comprises a base 10, a rod 20 and a shade 30.

The base 10 includes a disk 11 with a recess 12 defined in a top thereof and a connection member 13 extends from a surface of the recess 12. A hole 130 is defined in a center of the connection member 13. A transparent cover 14 is mounted to the recess 12 and includes a notch 141 with which the connection member 13 is engaged.

The cover 14 includes three protrusions 142 and three engaging holes 121 are defined in an inner periphery of the recess 12. The protrusions 142 are engaged with the engaging holes 121.

The rod 20 is a flat and elongate rod and a cable 21 extends through inside of the rod 20. The rod 20 has a first end pivotably connected to the hole 130 of the connection member 13 so that the rod 20 can be pivoted about the connection member 13. The rod 20 has two pivots 23, 22 connected to the first and second ends thereof.

The shade 30 is a semi-transparent or transparent member and connected to the pivot 22 on the second end of the rod 20, so that the shade 30 can be pivoted about the pivot 22 and positioned at desired angle. The cable 21 is connected to a socket (not shown) in the shade 30. The shade 30 includes an opening 31 and a tapered end member 32 is removably connected with the opening 31. The end member can be easily removed from the opening 31 of the shade 30.

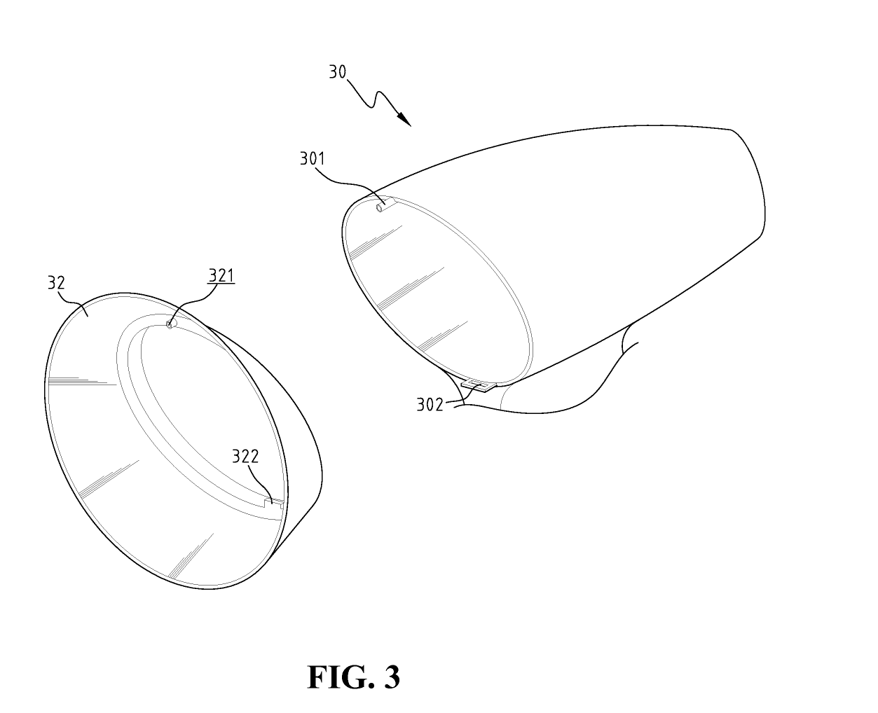

As shown in FIG. 3, a connection post 301 extends from a periphery of the opening 31 of the shade 30 and a connection tab 302 is connected to the periphery of the opening 31. A through hole is defined in the connection tab 302. A mounting hole 321 is defined in the end member 32 so as to be engaged with the connection post 301. An insertion 322 extends from the end member 32 so as to be engaged with the through hole in the connection tab 302.

A first decoration member 40 is received in the recess 12 and can be is a photo, a picture, a colored piece or a patterned sheet. The cover 14 can be easily mounted to or removed from the recess 12 so as to easily replace the first decoration member 40. The first decoration member 40 may have the same shape as the cover 14.

A second decoration member 50 is received in the shade 30 and can be is a photo, a picture, a colored piece or a patterned and colored sheet. The end member 32 can be easily mounted to or removed from the shade 30 so as to easily replace the second decoration member 40. The second decoration member 50 may have the same shape as the shade 30.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A table lamp comprising:
a base including a disk with a recess defined in a top thereof, a connection member extending from a surface of the recess, a first decoration member received in the recess, a transparent cover mounted to the recess and including a notch with which the connection member is engaged;
a rod having a first end pivotably connected to the connection member, and
a shade being a semi-transparent or transparent member and connected to a second end of the rod, the shade including an opening and an end member is removably connected with the opening, a second decoration member received in the shade.

2. The table lamp as claimed in claim 1, wherein the connection member has a hole defined therein and the first end of the rod is pivotably inserted in the hole.

3. The table lamp as claimed in claim 1, wherein the cover includes at least two protrusions, and at least two engaging holes are defined in an inner periphery of the recess, the protrusions are engaged with the engaging holes.

4. The table lamp as claimed in claim 1, a connection post and a connection tab extend from a periphery of the opening of the shade, a through hole is defined in the connection tab, and a mounting hole is defined in the end member so as to be engaged with the connection post, an insertion extends from the end member so as to be engaged with the through hole of the connection tab.

5. The table lamp as claimed in claim 1, wherein the rod has two pivots connected to the first and second ends thereof.

6. The table lamp as claimed in claim 5, wherein the shade is pivotably connected to the pivot on the second end of the rod, whereby the shade is pivotable about the pivot.

7. The table lamp as claimed in claim 1, wherein the first decoration member in the recess is a photo, a picture, a colored piece or a patterned sheet.

8. The table lamp as claimed in claim 1, wherein the first decoration member has the same shape as the cover.

9. The table lamp as claimed in claim 1, wherein the second decoration member includes different patterns and colors.

10. The table lamp as claimed in claim 1, wherein the second decoration member has the same shape as the shade.
